(19) United States
(12) Patent Application Publication
(10) Pub. No.: US 2006/0039037 A1
(43) Pub. Date: Feb. 23, 2006

(54) Image delivering apparatus and image forming apparatus

(75) Inventor: Koichi Shibata, Sakai-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/002,761

(22) Filed: Dec. 3, 2004

(30) Foreign Application Priority Data
Aug. 19, 2004 (JP) 2004-239829

(51) Int. Cl. H04N 1/41

(52) U.S. Cl. 358/426.01; 358/505; 358/426.16; 358/426.15

(57) ABSTRACT

An image delivering apparatus is provided comprising a reader for reading the image of an original, a delivery portion for delivering data of the image read by the reader to a destination on a network, a display for displaying a screen of settings to be used for delivering the data of the image from the delivery portion, a screen capture portion for capturing the screen of settings filled with entry data in a given procedure, a storage portion for storing the captured screen of settings as a screen data, and an output portion for releasing the screen data saved in the storage portion.

This application claims priority under 35 U.S.C.§119 to Japanese Patent Application No. P2004-239829 filed on Aug. 19, 2004, the entire disclosure of which is incorporated herein by reference in its entirety.

### BACKGROUND OF THE INVENTION

1. Field of the Invention

The present invention relates to an image delivering apparatus and an image forming apparatus arranged to have a function of delivering an image data read by a scanner to a specified destination over a network in the form of Scan to FTP (file transfer protocol), Scan to SMB (server message block), or E-mail.

2. Description of Related Art

The following description sets forth the inventor's knowledge of related art and problems therein and should not be construed as an admission of knowledge in the prior art.

Multi purpose machines or MFP (multi function peripheral) apparatuses are provided for operating multi functions including, for example, copying, printing, and delivering an image data read from an original in the form of Scan to FTP, Scan to SMB, or E-mail to a specified destination over a network.

It is essential for delivering such the image data to a specified destination on the network to carry out the entry of delivery setting information, which include the network and the destination, through an operation panel.

While the MFP apparatus is functioned with a variety of scanning techniques including Scan to FTP, Scan to SMB, and Scan to E-mail, its setting for each scanning function will be troublesome for any unskilled user.

Particularly, the procedure of entry for the MFP setting is varied but not standardized. Also, as the setting is conducted only once at the initial operation, its procedure will hardly be remembered. Accordingly, the procedure for the setting can remain unfamiliar to the unskilled user.

An improvement of the procedure is proposed in Japanese Patent Laid-open Publication 2003-122199 where an unskilled user who is unfamiliar with the operation of touch keys on the operation panel of, e.g., a digital copy machine can be assisted by voice guidance for ease of the operation when it is judged after a given period of time elapsed idle that the user's action is in trouble.

However, since most of the MFP apparatuses are used in business offices and their settings largely depend on the environments about networks, their operation may hardly be understood through reading their manuals or documents supplied by the manufacturers. It is yet troublesome for unskilled users to carry out the initial setting of an MFP apparatus with no help of skilled users or experts.

In addition, as the multi functions include not only the setting for networks but also so-called universal sending techniques in different protocols, they will be operated with very much difficulty.

It is hence known that no prior art permit unskilled users to conduct readily the initial setting of every apparatus through the voice guidance.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an image delivering apparatus which allows any beginner or unskilled user to conduct the setting for the delivery action with much ease.

Among other potential advantages, some embodiments can provide an image forming apparatus which allows any beginner or unskilled user to conduct the setting for the delivery action with much ease.

According to a first aspect of a preferred embodiment of the present invention, an image delivering apparatus, comprises:
a reader for reading an image of an original,
a delivery portion for delivering data of the image read by the reader to a destination on a network,
a display for displaying a screen of settings to be used for delivering the data of the image from the delivery portion,
a screen capture portion for capturing the screen of settings filled with entry data in a given procedure,
a storage portion for storing the captured screen of settings as a screen data;
and an output portion for outputting the screen data saved in the storage portion.

According to a second aspect of a preferred embodiment of the present invention, an image delivering apparatus, comprises:
a reader for reading an image of an original,
a delivery portion for delivering data of the image read by the reader to the destination on a network,
a display for displaying a screen of settings to be used for delivering the data of the image from the delivery portion,
a storage portion for storing entry data provided previously on the screen of settings; and
a controller for displaying the previous entry data saved in the storage portion as a reference data on the screen of settings at the succeeding setting action.

According to a third aspect of a preferred embodiment of the present invention, an image delivering apparatus, comprises:
a reader for reading an image of an original,
a delivery portion for delivering data of the image read by the reader to the destination on the network,
a display for displaying a screen of settings to be used for delivering the data of the image from the delivery portion,
a storage portion for storing entry data to be provided on the screen of setting; and
a controller for displaying the entry data saved in the storage portion as a pull-down menu on the display for ease of the setting.

According to a fourth aspect of a preferred embodiment of the present invention, an image forming apparatus, comprises:
a reader for reading an image of an original,
a printer for printing data of the image read by the reader,
a delivery portion for delivering the data of the image read by the reader to the destination on the network,
a display for displaying the screen of settings to be used for delivering the data of the image from the delivery portion,
a screen capture portion for capturing the screen of settings filled with entry data in the given procedure,
a storage portion for storing the captured screen of settings as a screen data; and
an output portion for outputting the screen data saved in the storage portion.

According to a fifth aspect of a preferred embodiment of the present invention, an image forming apparatus, comprises:
a reader for reading an image of an original,
a printer for printing data of the image read by the reader,
a delivery portion for delivering the data of the image read by the reader to the destination on the network,
a display for displaying the screen of settings to be used for delivering the data of the image from the delivery portion,
a storage portion for storing entry data provided previously on the screen of settings;
and a controller for displaying the previous entry data saved in the storage portion as the reference data on the screen of settings at the succeeding setting action.

According to a sixth aspect of a preferred embodiment of the present invention, an image forming apparatus, comprises:
a reader for reading an image of an original,
a printer for printing data of the image read by the reader,
a delivery portion for delivering the data of the image read by the reader to the destination on the network,
a display for displaying the screen of settings to be used for delivering the data of the image from the delivery portion,
a storage portion for storing entry data to be provided on the screen of setting;
and a controller for displaying the entry data saved in the storage portion as a pull-down menu on the display.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram of the MFP apparatus as the image delivering apparatus illustrating one embodiment of the present invention;

FIG. 2A is a flowchart of the setting action to be conducted by a manager or skilled user and FIG. 2B is a flowchart of the response action to be operated with the MFP apparatus;

FIG. 3 is a view showing a screen of settings to be filled at Steps S102 and S104 of the flowchart shown in FIG. 2;

FIG. 4 is a view showing a screen of settings to be filled at Steps S106 and S108 of the flowchart shown in FIG. 2;

FIG. 5 is a view showing a screen for transmitting an E-mail displayed on an operation panel of the MFP apparatus;

FIG. 6 is a view showing a screen of settings display on the operation panel for conducting the transmitting action while previous entry data are displayed for reference; and

FIG. 7 is a view showing a series of screens for conducting the setting action with the use of a pull-down menu.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

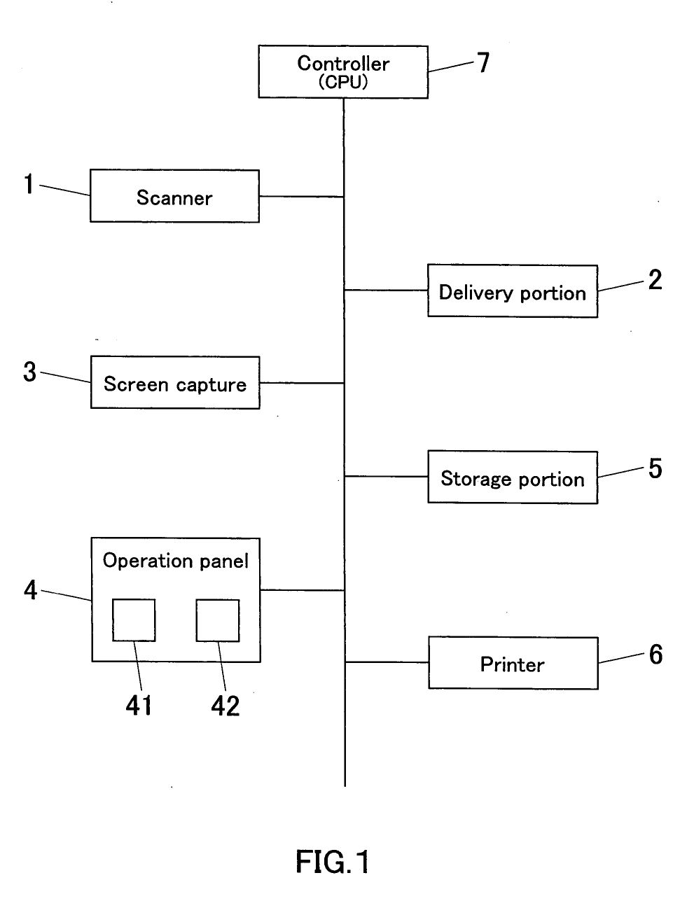

FIG. 1 is a block diagram of an MFP apparatus as the image delivering apparatus illustrating one embodiment of the present invention.

As shown in FIG. 1, the MFP apparatus comprises a scanner 1, a delivery portion 2, a screen capture portion 3, an operation panel 4, a storage portion 5, a printer 6, and a controller 7.

The scanner 1 is provided as a reader for scanning the image of an original placed on a platen glass (not shown) to obtain a data of the image.

The delivery portion 2 is provided as one of the output portions for delivering (outputting) the image data scanned by the scanner 1 or a data of a setting screen read by the screen capture portion 3, explained below in more detail, in the form of E-mail, SMB or FTP format to a specified destination.

The screen capture portion 3 is provided for capturing the screen of settings prepared by a skilled user, e.g., a manager or a power user, in a procedure of given steps so that a beginner or unskilled user can refer to it when operating the operation panel 4 for monitoring the setting of delivery such as the setting of network.

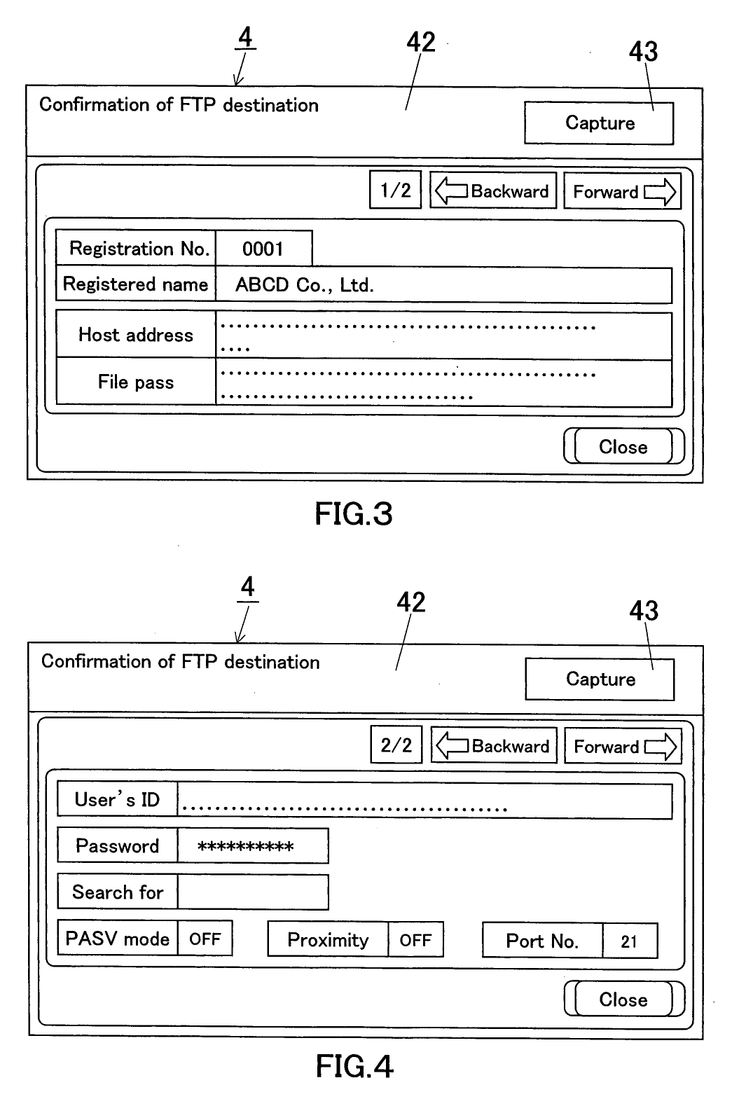

The operation panel 4 comprises a keyboard 41 including an array of setting keys, a start button switch, and ten keys and a display 42 such as an LCD. In the delivery setting mode, the display 42 displays a touch-inputtable screen settings for entry of data. Also, it displays a capture button 43 of a touch key type (See FIGS. 3 and 4) for starting the action of the screen capture portion 3 of capturing the screen of settings.

The storage portion 5 is a memory for storage of the image data of an original scanned by the scanner 1, the data of destinations, and other data. The screen of settings captured by the screen capture portion 3 is then stored in the storage portion 5 as a screen data. Its storage area is preferably arranged of a non-volatile format but may be volatile (as will be explained hereinafter as a non-volatile area).

The printer 6 prints the image data and other data on a sheet of paper. Also, the printer 6 is provided as one of the output portion for outputting the screen data.

The controller 7 is provided with a CPU for controlling the entire actions of the MFP apparatus. For example, the controller 7 directs the scanner 1 to scan an original in response to a start command entered by the user, the screen capture portion 3 to capture the screen of settings upon the capture button 43 being pressed down or the entry of a setting command, the storage portion 5 to save the screen data captured, the printer 6 to print the screen data or the image data on the sheet of paper, the delivery portion 2 to transmit the screen data in an E-mail form or the like, and the display 42 of the operation panel 4 to display the screen of settings or a pull-down menu.

When the MFP apparatus shown in FIG. 1 is operated by a skilled user such as the manager or the power user for setting delivery, its setting procedure is captured as a screen shot by the screen capture portion 3 and then saved in the storage portion 5.

More specifically, when the setting of delivery is conducted and the capture button 43 provided on the display 42 of the operation panel 4 is pressed down by the skilled user finding a point of setting, the screen of settings displayed at the time on the display 42 is captured in.

The aforementioned “point of setting” means the timing when each setting item is entered. For example, in the Scan to SMB (server message block) mode, the “point of the setting” means the timing of entering the protocol to be used, the name of a host, the pass to a folder, the ID number or the password.

Whenever the setting data is entered and the capture button 43 is pressed down on the screen of settings, the screen data displayed on the display 42 is captured. As all the settings have been entered, a desired number of the screens of settings are captured as the screen data and saved in the storage portion 5.

On the other hand, the apparatus allows an unskilled user who is unfamiliar with the setting to either print on sheets of paper the screen data saved in the storage portion 5 prior to the setting action or, when the screen data is greater than the screen size of the display 42, display a desired number of the screen data at once in a smaller size or one after another by operating a selector switch (not shown) and thus follow the procedure of steps displayed on the screen for the setting. Accordingly, regardless of the MFP apparatus connected under network environments, the unskilled user can conduct the setting action easily and readily without being taught by the skilled user or manager.

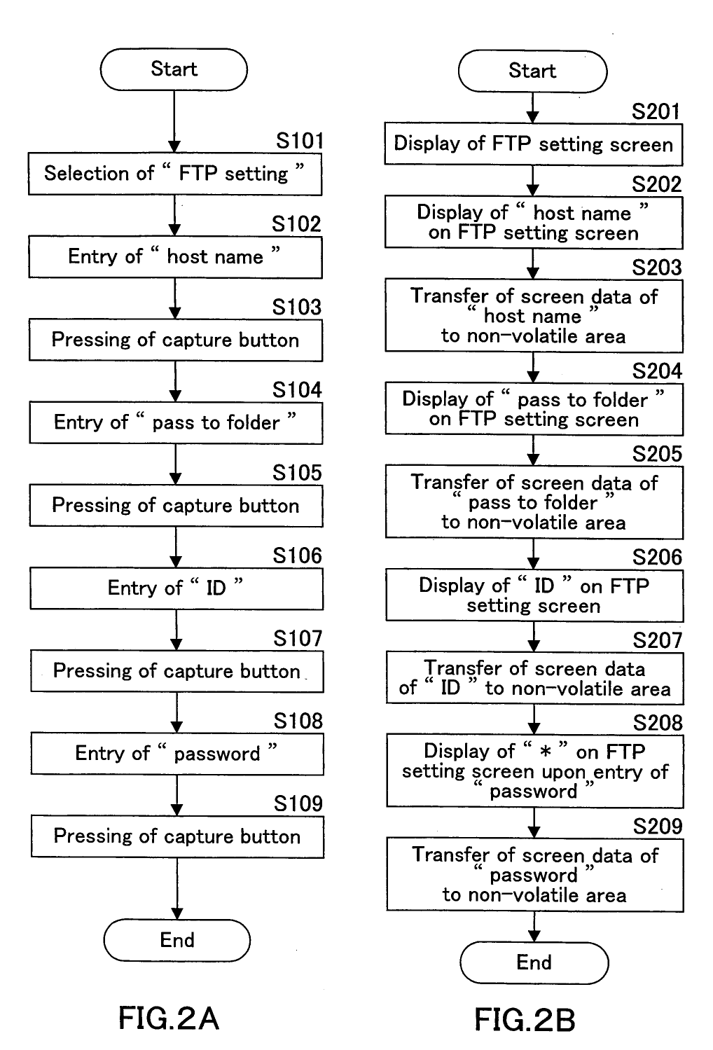

The setting action of the skilled user and its response in the MFP apparatus will now be described referring to a flowchart of FIG. 2. FIG. 2A illustrates the setting action of the skilled user while FIG. 2B illustrates the response of the MFP apparatus. Each step in the description as well as the flowchart is expressed by simply S.

As shown in FIG. 2, the procedure starts with S101 where the skilled user selects the delivery mode through the operation panel 4. In this embodiment, the mode of Scan to FTP is selected. When mode is selected, the MFP apparatus 1 conducts S201 for displaying the screen of FTP setting on the display 42 as shown in FIG. 3.

This is followed by the skilled user entering the name of a host (“Host Address” in FIG. 3) at the S102. Then, the name of the host entered is displayed on the FTP setting screen at the S202.

At S103, the capture button 43 is pressed down by the skilled user. In response, the MFP apparatus captures the screen of settings with the name of the host and transfers them as the host data to the non-volatile storage area of the storage portion 5 at S203.

S104 follows where the pass to a folder is entered by the skilled user (“File Path” in FIG. 3). The MFP apparatus then displays “File Path” on the FTP setting screen at S204.

At S105, the capture button 43 is pressed down by the skilled user. In response, the MFP apparatus captures the screen of settings with the file path and transfers them as a file path data to the non-volatile storage area of the storage portion 5 at S205.

Similarly, after switching the screen of settings to one shown in FIG. 4 through pressing the forward button, the skilled user enters the ID at S106, presses down the capture button 43 at S107, enters the password at S108, and presses down the capture button 43 at S109 before terminating the procedure of the setting action.

In response, the MFP apparatus displays the ID on the FTP setting screen at S206 when the ID is entered, captures the screen at S207 when the capture button 43 is pressed down, and transfers the screen of settings as an ID data to the non-volatile storage area. Also, the MFP apparatus displays “*” on the FTP setting screen for security at S208 when the password is entered, captures the screen data at S209 when the capture button 43 is pressed down, and transfers the screen data as a password data to the non-volatile storage area before terminating the procedure of the setting action.

According to the steps mentioned above, the screen data is captured and saved in the storage portion 5 whenever its blank on the screen has been filled with each setting data entered by the skilled user.

The screen data are then retrieved from the storage portion 5 and printed by any unskilled user operating the printer 6. This allows the unskilled user to follow the screen data printed for conducting the procedure of steps for the setting.

Alternatively, the screen data saved in the storage portion 5 may be delivered in the form of E-mail of a data file directly to the desired destination but not printed with the printer 6.

The screen for transmitting the screen data in the form of E-mail displayed on the display 42 is shown in FIG. 5. The screen of transmission appears when the key of “Capture screen transmission” is pressed down. In this embodiment, the transmission can be carried out in the form of E-mail, FTP, or SMB format. The destination can be entered directly in the destination field or blank.

While the screen of settings is saved, but not limited to, whenever the capture button 43 is pressed down in the embodiment, it may automatically be stored in the storage portion 5 when it is judged that the entry of settings has been completed at the timing, for example, when the cursor is moved from the settings to be entered in the Scan to FTP mode including the name of the host, the pass to folder, the ID, and the password to the other setting. Also, when the screen data consists of several pages, each page of the setting screen can systematically be captured just before shifting to the next page and saved in the storage portion 5.

In another embodiment, the previously entered data of the screen settings which have been saved in the storage portion 5 may be read and displayed in the corresponding blanks on the screen for allowing a user to selectively determine the settings.

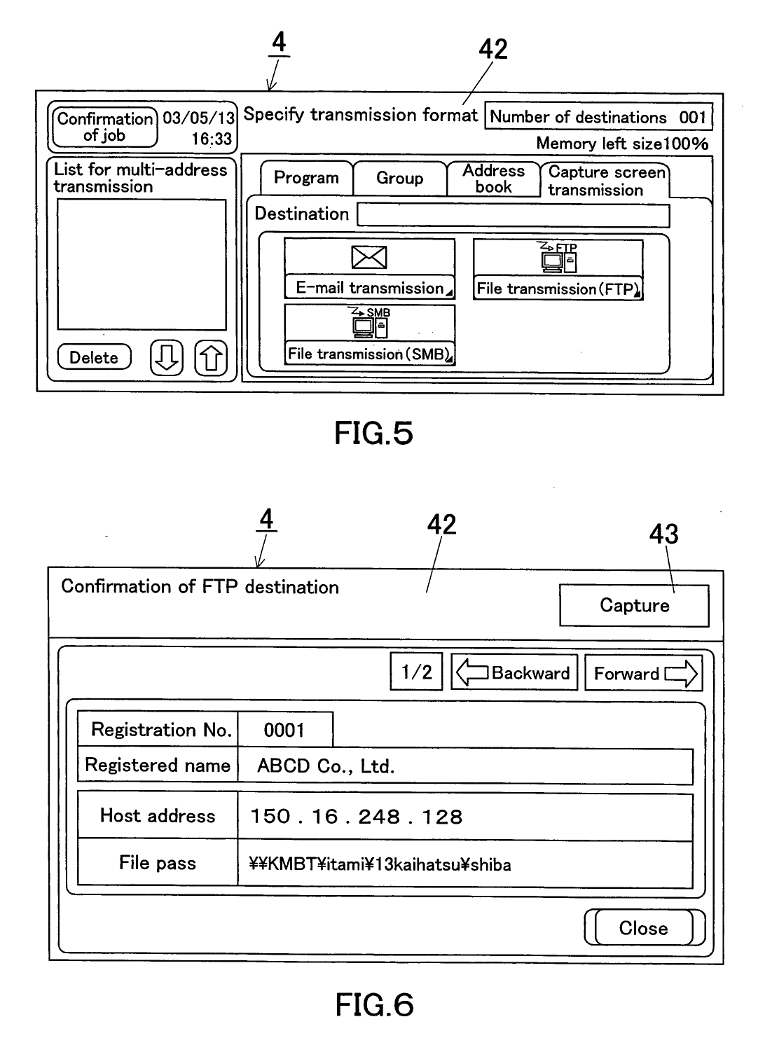

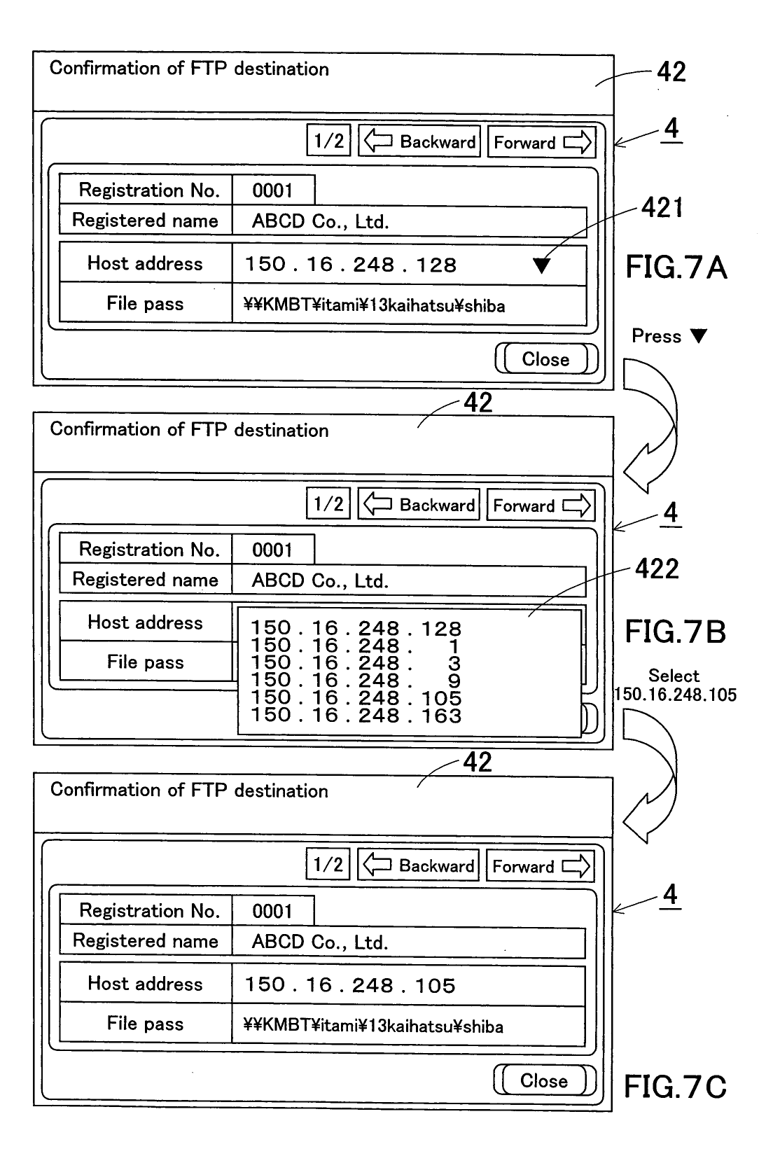

More particularly unlike the previous embodiment, the entered data of the screen settings used in the past actions are saved in the storage portion 5 and when the entry of setting data is desired by a user, they can be read and displayed in the corresponding blanks on the screen as shown in FIG. 6 with no use of the capture button 43. This allows the user to easily enter its desired settings while reviewing the previous setting data. The entered data of the screen settings may be the most previously entered data or a list of the data prepared and entered in advance by the manager or skilled user.

In a further embodiment, the entry of settings may be preceded by the display of the data of each setting in the form of a pull-down menu which has been read from the storage portion 5. This allows the user to select desired one of the data from the menu for the particular setting.

It is assumed that, for example, a list of the host addresses has been entered and saved by the manager or skilled user. When the user clicks the black triangle marking 421 in the host address blank on the screen shown in FIG. 8A, the (pull-down menu) list 422 of the host addresses appears as shown in FIG. 8B. Then, the user selects one of the host addresses prepared by the skilled user, for example, “150.16.105” in the figure. The host address blank is filled with “150.16.105” as shown in FIG. 8C. The other settings can be entered by the same manner. The data of the pull-down menu in the further embodiment which have been read from the storage portion 5 and displayed on the display 42 by the action of the controller 7 may be of a group prepared by the skilled user or of an accumulation entered through a series of the preceding setting actions.

It would be understood that the present invention is not limited to the above described embodiments. For example, while the delivery mode is described with the Scan to FTP format, it may be any other appropriate format.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An image delivering apparatus comprising:
a reader for reading an image of an original;
a delivery portion for delivering data of the image read by the reader to a destination on a network;
a display for displaying a screen of settings to be used for delivering the data of the image from the delivery portion;
a screen capture portion for capturing the screen of settings filled with entry data in a given procedure;
a storage portion for storing the captured screen of settings as a screen data; and
an output portion for outputting the screen data saved in the storage portion.

2. The image delivering apparatus according to claim 1, wherein the capturing of the screen of settings by the screen capture portion is conducted by the turning on of a capture button.

3. The image delivering apparatus according to claim 1, wherein the capturing of the screen of settings by the screen capture portion is conducted automatically at a specific timing.

4. The image delivering apparatus according to claim 3, wherein the specific timing is when one of the entry data has been entered.

5. The image delivering apparatus according to claim 1, wherein the output portion transmits the screen data saved in the storage portion in the form of an E-mail.

6. The image delivering apparatus according to claim 1, wherein the output portion is a printer that prints the screen data saved in the storage portion.

7. An image delivering apparatus comprising:
a reader for reading an image of an original;
a delivery portion for delivering data of the image read by the reader to the destination on the network;
a display for displaying a screen of settings to be used for delivering the data of the image from the delivery portion;
a storage portion for storing entry data provided previously on the screen of settings; and
a controller for displaying the previous entry data saved in the storage portion as a reference data on the screen of settings at the succeeding setting action.

8. The image delivering apparatus according to claim 7, wherein the controller displays update entry data provided at the time of setting as the reference data on the screen of settings.

9. The image delivering apparatus according to claim 7, wherein the controller displays predetermined entry data as the reference data on the screen of settings.

10. An image delivering apparatus comprising:
a reader for reading an image of an original;
a delivery portion for delivering data of the image read by the reader to the destination on the network;
a display for displaying a screen of settings to be used for delivering the data of the image from the delivery portion;
a storage portion for storing entry data to be provided on the screen of setting; and
a controller for displaying the entry data saved in the storage portion as a pull-down menu on the display.

11. The image delivering apparatus according to claim 10, wherein the controller displays predetermined entry data as the pull-down menu on the display.

12. The image delivering apparatus according to claim 10, wherein the controller displays accumulated entry data saved previously at every setting action as the pull-down menu on the display.

13. An image forming apparatus comprising:
a reader for reading an image of an original;
a printer for printing data of the image read by the reader;
a delivery portion for delivering the data of the image read by the reader to the destination on the network;
a display for displaying a screen of settings to be used for delivering the data of the image from the delivery portion;
a screen capture portion for capturing the screen of settings filled with entry data in a given procedure;
a storage portion for storing the captured screen of settings as the screen data; and
an output portion for outputting the screen data saved in the storage portion.

14. The image forming apparatus according to claim 13, wherein the capturing of the screen of settings by the screen capture portion is conducted by the turning on of the capture button.

15. The image forming apparatus according to claim 13, wherein the capturing of the screen of settings by the screen capture portion is conducted automatically at the specific timing.

16. The image forming apparatus according to claim 15, wherein the specific timing is when one of the entry data has been entered.

17. The image forming apparatus according to claim 13, wherein the output portion transmits the screen data saved in the storage portion in the form of an E-mail.

18. The image forming apparatus according to claim 13, wherein the output portion is a printer that prints the screen data saved in the storage portion.

19. An image forming apparatus comprising:
a reader for reading an image of an original;
a printer for printing data of the image read by the reader;
a delivery portion for delivering the data of the image read by the reader to the destination on the network;
a display for displaying a screen of settings to be used for delivering the data of the image from the delivery portion;
a storage portion for storing entry data provided previously on the screen of settings; and
a controller for displaying the previous entry data saved in the storage as the reference data on the screen of settings at the succeeding setting action.

20. The image forming apparatus according to claim 19, wherein the controller displays update entry data provided at the time of setting as the reference data on the screen of settings.

21. The image forming apparatus according to claim 19, wherein the controller displays predetermined entry data as the reference data on the screen of settings.

22. An image forming apparatus comprising:
a reader for reading an image of an original;
a printer for printing data of the image read by the reader;
a delivery portion for delivering the data of the image read by the reader to the destination on the network;
a display for displaying a screen of settings to be used for delivering the data of the image from the delivery portion;
a storage portion for storing entry data to be provided on the screen of setting; and
a controller for displaying the entry data saved in the storage portion as the pull-down menu on the display.

23. The image forming apparatus according to claim 22, wherein the controller displays predetermined entry data as the pull-down menu on the display.

24. The image forming apparatus according to claim 22, wherein the controller displays accumulated entry data saved previously at every setting action as the pull-down menu on the display.
